(19) United States
(12) Patent Application Publication
(10) Pub. No.: US 2003/0031167 A1
(43) Pub. Date: Feb. 13, 2003

(54) Methods and system for efficient route lookup

(76) Inventors: Abhishek Ranjan Singh, Rockville, MD (US); Vishnu Natchu, San Jose, CA (US)

Correspondence Address: Godwin Gruber, P.C., Suite 655, 801 E. Campbell Rd., Richardson, TX, 75081, US

(21) Appl. No.: 10/033,038

(22) Filed: Jan. 2, 2002

Related U.S. Application Data
(60) Provisional application No. 60/271,970, filed on Feb. 28, 2001.

(51) Int. Cl. H04L 12/28

(52) U.S. Cl. 370/352; 370/408

(57) ABSTRACT

A method and system for performing a route lookup in a routing system, including a plurality of routes places a bound on the number of accesses to the memory necessary to perform a route lookup and guarantees the minimal amount of memory to achieve a particular bound. For each node the memory required to meet a bound on the depth of the tree rooted at that node is computed, given the distribution of routes in the network. A route can be added or deleted which changes the topology and hence the memory required to meet the bound, but not all nodes need to recalculate their costs, and an incremental algorithm minimizes the overall costs of performing a route topology change and the subsequent lookup

### CROSS REFERENCE TO RELATED APPLICATIONS

This application is related to Provisional Application Serial No. 60/271,970 entitled “NEW COMPRESSED RADIX TREE,” by Abhishek R. Singh, filed Feb. 28, 2001, the entirety of which is incorporated herein by reference. This application claims priority on the aforementioned related provisional application.

### TECHNICAL FIELD

The present invention relates generally to Internet Protocol (IP) based data networks (IP networks) and, more specifically, to a method and system for bounding the time required for searching for a longest prefix match (LPM) of a destination IP address when forwarding packets using a router. Still, more particularly, the present invention relates to methods of placing a bound of the number of accesses necessary to perform a route lookup that allows IP packets to be switched at wire speed.

### BACKGROUND OF THE INVENTION

Without limiting the scope of the invention, its background is described in connection with modern day high speed data networks utilized as a transport mechanism for packetized data.

In packet-switched networks, data is transmitted in a series of packets as opposed to complete segments of data. During transmission, data is broken up and converted into a series of packets which, in turn, are sent over communications links coupling nodes of the network. The links may be high speed optical links, copper wiring, wireless, and/or other communication medium with switching elements at each node forming the end-to-end communications pathways between the nodes such that a virtual pathway is defined between points of origination and points of destination in the network.

Generally, data packets are assembled according to standardized transmission protocols that require the origination/destination information be included in the packet. As a packet is received at one node, the portion of the packet stream that includes the destination address is inspected in order to determine where the packet should be routed. This function is facilitated by a router, that includes appropriate routing algorithms and one or more routing table(s) with entries for every destination serviced by the router. In an effort speed up the routing function, an inspection of the destination address can be limited to its prefix instead of the entire destination address. Thus, searching and locating an appropriate prefix match for a destination address is a key function in forwarding data packets within the router's switch fabric.

The most obvious method of prefix match involves the use of a binary tree architecture. A binary tree is a known data structure with nodes which can denote all possible prefixes. Thus, as a logic structure for routing IP packets, bit patterns can be stored compactly in a binary tree structure permitting longest prefix match. The use of binary trees for prefix match, however, can result in inefficiency and waste of precious memory since binary trees do not bound the number of accesses necessary to determine the best route path to a destination. Therefore, the amount of memory necessary to achieve a bound can not be minimized using a binary tree as the lookup architecture.

A compressed radix tree (CRT) is a compromise lookup architecture with a structure based on the binary tree which is designed to speed up a search for a network node without wasting too much memory. An example, of a CRT is shown and described in U.S. Pat. No. 5, 946,679 to Ahuja et al., dated Aug. 31, 1999. Essentially, with a CRT a node assumes the role of a lookup table and compression techniques are used to optimize memory for sparse distribution of bit strings that represent the node in memory. When a CRT architecture is used for performing a route lookup for a destination address, the CRT may not include all the routes. For example, some parent routes can be eclipsed if all of the child routes belonging to the parent route have more specific routes. In addition, the bound on a lookup for a CRT based architecture is sixteen memory accesses. This arrangement may be suboptimal both in terms of memory and lookup speed.

For Internet Protocol (IP), the IP routing table provides a lookup architecture that typically consists of route entries each of which has a key, a length, and appropriate forwarding information. The key can be any number limited, for example, to 32 bits in length. An IP router performs a route lookup by matching an IP destination address in every packet against routes contained in the IP routing table. The IP destination address matches a route, with a key (k) and length (l), if top (l) bits of the IP destination address in a data packet are exactly equal to the top (l) bits of the key (k). The result of a routing table lookup is a route with the longest key length which matches the data packet's IP destination address. Thus, to increase speed of routing a data packet, the size of a CRT node's lookup needs to be able to be varied based on the distribution of prefixes (or routes) which in certain instances may need more than two bits to be optimal.

For each node in the binary tree, the cost of constructing an optimal CRT rooted at a specific node and meeting a bound on lookup time is known as a “cost array.” This array is indexed by the bound it seeks to impose at that node. The cost array for sharing routes is dependant upon the height of a node in the binary tree. Once costs for all the nodes in the tree have been calculated for a given route/prefix distribution, the cost of an optimal CRT can be determined by walking the tree starting at the root of the binary tree. Since each node also stores the lookup size corresponding to the bound that will be kept, an optimal CRT can be generated.

However, a disadvantage of using the cost of constructing an “optimal” CRT rooted at a specific node and meeting a bound on lookup time is that an add/delete operation can dramatically change the data structure. Hence, in the worst case, the structure of the whole CRT can change. These consequences are not desirable if a bound on the change produced by the add/delete operation is also needed. Moreover, such a bound is necessary when multiple copies of the CRT are needed to be synchronized in real time.

Therefore, what is needed is a means of accommodating changes in the CRT structure that occur, for example, from the addition or deletion of a route in the network. A solution that allows the lookup size of a node to be increased or decreased without increasing the cost of the update would provide numerous advantages. Such a solution should allow a bound to be placed on the number of accesses to the lookup architecture and guarantee a minimum amount of memory to achieve the bound.

### SUMMARY OF THE INVENTION

The present invention provides methods and a related system for bounding the number of accesses to the lookup resources used for to perform a destination address prefix match associated with the routing of a data packet. The invention ensures that minimum amount of memory is used to achieve a particular bound and minimizes the impact of updates, such as route additions or deletions, providing the optimal solution even when an add and/or delete operation is performed. Thus, costs associated with route lookup of a specific destination address may have to be recalculated, but an incremental algorithm ensures that the cost associated with all nodes are not affected by the addition or deletion of the route and need no recomputation. The invention utilizes incremental dynamic programming to ensure that when a route is added or deleted, only the nodes effected by the addition or deletion need to have their cost arrays recalculated.

Therefore, according to one embodiment, disclosed for use in a data network with a router having memory for storing entries for a plurality of destinations from the router, is a method of performing route lookup that places a bound on the number of accesses to the memory. The method comprises the steps of determining the costs of all possible lookup architectures that can be constructed given the distribution of destinations in the data network. Next, a lookup architecture is chosen which requires the minimum amount of memory to obtain the next hop of any destination and that places a bound on the number of memory accesses to obtain the next hop. Finally, after receipt of a data packet, the chosen lookup architecture is used to lookup a route for a destination address associated with the data packet.

In practice, the contents of an address associated with a data packet are determined and matched with the contents of memory associated with a node in the routing system. For any given address, the number of accesses to memory, required to perform the route lookup based on the distribution of nodes in the routing system, is bounded. The lookup architecture always returns the longest prefix match in a bounded amount of time (or, memory accesses).

Also disclosed is a method for performing a route lookup in a router for a data packet having an associated destination address. The method comprises the steps of inspecting the destination address associated with the data packet and using the destination address to access a memory space containing a lookup architecture to arrive at the next hop for the data packet which is serviced by the router where the lookup architecture is adapted for bounding the number accesses to the memory space for any destination address of the data packet. Preferably, the lookup architecture is further adapted to minimize the amount of memory required to meet any bound on accesses to the memory space for any particular destination address.

Further disclosed for use in a data network including a plurality of destinations and a plurality of routes for reaching the destinations, is a router adapted to minimize the costs of route lookup for data packets routed in the data network. The router comprises an interface to incoming links of the data network and logic means for receiving incoming data packets from the data network through the interface and for determining the destination of data packets, determining the route to the next hop along a destination, and routing data packets on a route extending to a next hop. The router further comprises memory space accessible by the logic means and adapted for storing a lookup architecture for routes, wherein the lookup architecture places a bound on the number accesses to the memory space for any destination address of the data packet. Preferably, the lookup architecture is further adapted to minimize the amount of memory required to meet any bound on accesses to the memory space for any particular destination address.

The present invention offers definite advantages over conventional destination address prefix match and route lookup methodologies. In particular, the amount of memory required to implement the prefix match algorithms can be minimized keeping the search in the lookup table bounded. Moreover, no significant increase in memory occurs as routes are added or deleted from route entries in the lookup architecture. Thus, add and delete operations become inexpensive in terms of the cost associated with performing a route lookup in an effort to facilitate a prefix match operation.

### BRIEF DESCRIPTION OF THE DRAWINGS

Other aspects of the invention, including specific embodiments, are understood by reference to the following detailed description in conjunction with the appended drawings in which:

FIGS. 1a and 1b are an exemplary illustration of a network for routing data packets with an IP address;

FIG. 2 shows a routing table configured as a binary tree;

FIG. 3 illustrates an algorithm for matching an IP destination address in accordance with the present invention;

FIG. 4 is an exemplary flowchart illustrating determining a least costly process for choosing a route in accordance with the present invention; and

FIG. 5 is an exemplary block diagram showing the use of the present invention in a routing system.

References in the detailed description correspond to like references in the figures unless otherwise indicated.

### DETAILED DESCRIPTION OF PREFERRED EMBODIMENTS

While the making and using of various embodiments of the present invention are discussed in detail below, it should be appreciated that the present invention provides many applicable inventive concepts which can be embodied in a wide variety of specific contexts.

To better understand the invention, reference is made to FIGS. 1a and 1b, which is an exemplary illustration of a network for routing data packets using IP addresses. First, a brief overview of the Internet Protocol (IP) and conventional IP addressing schemes. IP is one of the protocols in the Transmission Control Protocol/Internet Protocol (TCP/IP) suite. The IP protocol provides a standard way for users to send and receive data by routing data traffic along nodes of the data network. IP can be used to route raw voice and video image data between nodes in a data network supporting IP. When necessary, the data is broken down into manageable units, called datagrams. The datagrams are transmitted within the IP network in standardized traffic units called packets.

Packets are typically created by electronically attaching a packet identifier, known as a frame header, directly to the datagram. The frame header will generally contain information such as a source address of the packet, a destination address of the packet, and other information, such as a protocol number and a checksum, for example. In this manner, the IP protocol is used for routing each individual packet to a destination address.

IP addresses, in IPv4 format, comprise a 32 bit address which may be coded as a dotted decimal notation such as “123.4.5.6”, for example. Each decimal number represents eight bits of binary data, and therefore can have a decimal value between 0 and 255. The first part of the IP address identifies the network on which a host resides while the second part of the IP address identifies the particular host on a given network. For example, “123.4” can be used to identify the IP network where the host is located, “0.5.” can be associated with a subnet associated with the host and “0.6” identifies the host. Subnetting divides the host number into two parts which includes the subnet number and the host number on the subnet. Other IP addressing conventions for the host may be used as well.

In this example, host 102 is connected via link 104 to router 106. Router 106, in turn, is connected to host 108 via link 110. Additionally, router 106 is connected to router 112 via link 110. Router 106 is also connected to network 114 which may be used to send and receive data from host 118 via link 1 16.

Router 106 may contain a routing table as illustrated in FIG. 1b. Routing table 120 comprises a lookup table that contains entries for every destination in the network and every subnetwork of the network in terms of its network number. In FIG. 1b, column 122 indicates how a network number is discovered. The network number may be discovered by direct connection to the router “C” or by learning the network information from a routing protocol “I ”. When router 106 receives a data packet, router 106 inspects the destination address in column 124 and determines the network number for the destination. Router 106 then looks up the destination subnetwork number and connection configuration in column 126 and forwards the data packet to a gateway IP address using routing table entry 130. Router 106 then sends the data packet via the interface in column 128 associated with routing table entry 130.

IP addresses are used to deliver packets of data across a network, such as network 114, in what is known as end-to-end significance. End-to-end significance means that the source IP address and the destination IP address remain constant as the data packet traverses the network. Each time a data packet travels through a router, such as, for example, router 106, router 106 will reference its routing table, such as routing table 120, to see if there is a match between the network number and the destination IP address of the data packet in the routing table 120. If a match is found, the data packet is forwarded to the next “hop” router, such as, router 112 to reach the network to which the data packets are being sent. If a match is not found, one of two things may happen. The data packet may be forwarded to a router which is known as a default router (not shown) or the data packet may be dropped by the router. Data packets may be forwarded to a default router in the belief that the default router has more network information in the default router's routing table and will therefore be able to route the data packet to the correct final destination.

FIG. 2 shows routing table 120 in FIG. 1b configured as a binary tree 200 with a tree-like architecture. The binary tree 200 provides a lookup architecture for use by a router's routing algorithms. Routing table 120 may be a four bit binary tree, for example. Nodes, for example, nodes 202, 204, 206 and 208 in binary tree 200 at the lowest levels are called leaves and have a height of “0”. The topmost node, for example, node 250, of binary tree 200 is called the root. A route can be placed on the binary tree by looking at the four bits in the IP address or “key” in order starting at the top of binary tree 200. Moving down binary tree 200, if a current bit is “0” a left fork is taken. If a current bit is “1” a right fork is taken.

For example, route 220 has a key with bits 0101. To place route 220 a left fork is taken at node 250, a right fork is taken at node 248, a left fork is taken at node 246, a right fork is taken at node 244 and eventually arriving at node 242 which is indicated as 5/4 in this example. If this procedure for all routes from the leaves upward is followed, so that a route is not overwritten with a longer key length by a route with a shorter key length, all routes may be removed from the routing table with key lengths less than the maximum key length.

In binary tree 200, the nodes are clustered densely into groups (e.g., 202, 204, 206 and 208 into one group and 230, 232, 234, and 236 into another group). However, these groups are themselves scattered sparsely around binary tree 200. Routes in an Internet backbone routing table exhibit similar properties. Routing tables, such as routing table 120 in FIG. 1, can get very large and Internet backbone routers can have thousands of routes defined within the routing table.

For example, a routing table that contains all 16 routes of key length 4 is considered. The structure that uses a minimum amount of memory to lookup these routes is a table containing those 16 routes. Route lookup may be performed by indexing into routing table 120 with 4 bits from a data packet's destination address. Routing table 120 of these 16 pointers is the most efficient data structure that may be employed for lookup operations. However, if routing table 120 contains only one route, the most efficient data structure is one that compares 4 bits from the destination address with the top 4 bits of the key associated with the route. If the comparison succeeds, the destination address matches the route. If the comparison does not succeed, the destination address does not match the route. Therefore, a decision can be made to determine where to compare and where to use a lookup table in which an efficient memory lookup structure may be built.

As can be appreciated from FIG. 2, an instruction within the router's routing algorithms can be used to compare the value at an arbitrary bit offset in the IP destination address of a data packet of a specific length with a given value. If the comparison succeeds, the instruction indexes into routing table 120 based on contents of the data packet at the offset for the specific length. Therefore, a set of comparison demultiplexing instructions can be written to perform a longest prefix match lookup of a given routing table. However, a persistent concern is to determine the size of the compare function and the demultiplexing function as each instruction for a given route that satisfies certain constraints. An example of such a constraint is, for a fixed amount of memory, what parameters should be allocated such that the instructions that need to be executed for any route in the routing table is minimized.

Thus, the present invention provides methods and a related system for an efficient lookup process for the destination address associated with a data packet during prefix match. Specifically, with the present invention a bound is imposed on the number of accesses to the memory which contains the lookup architecture, such as routing table. Moreover, the amount of memory required to meet a particular bound is minimized. Therefore, when the bounds are established and the amount memory required to satisfy a particular bound is minimized, costs associated with route lookup are also minimized. The costs associated with route lookup can be computed in terms of memory required to store the route lookup architecture. By this process, whenever an addition and/or deletion of a node (or route) is performed, only the costs for nodes in the path that contains the added or deleted node needs to be calculated and the costs associated with a route lookup on the unaffected nodes remains unchanged.

FIG. 3 illustrates the use of a binary tree for longest prefix match of an IP destination address according to the present invention. In this example, decision tree 300, having a tree-like architecture, provides the lookup structure that stores a given set of routes along with a maximum height of each node. For simplicity, the terms “decision tree” and “tree-like architecture” will be used interchangeably throughout. It is contemplated, therefore, that the tree-like architecture 300 would be stored in a memory space containing route entries in a compressed form to form a Compressed Radix Tree (CRT).

A method based upon the lookup structure of tree-like architecture 300 would involve computing the cost of a lookup that is executed with one memory access for each node in the tree-like architecture 300 (this can be referred to as the node's one-cost). One way to do this lookup with only one memory access is to compare a longest chain down to the root of tree-like architecture 300, and then doing a demultiplexing process for the remaining bits associated with the height of this root in tree-like architecture 300. In other words, the size of lookup is based on the height of the compressed root in tree-like architecture 300.

Two-cost of a node in tree-like architecture 300, or a lookup in a maximum of 2 accesses may be computed by performing a compare-demultiplexing process for k bits, and then computing the one-cost of all nodes at a depth k below this node in tree-like architecture 300. In other words, two-cost of a node is the sum of a compare-demultiplexing process of k bits, and the one-cost of all the nodes at a depth k below this node. The optimal two-cost is obtained by varying k, and finding the value of k that yields the minimum two-cost. This optimal cost of a node in tree-like architecture 300 is the node's two cost. Thus, by varying k, we can find the lookup architecture that can do a lookup in two steps, and that requires the least amount of memory.

In this manner, a determination is made as to how much memory is required to perform a lookup in one memory access, or multiple memory accesses for every node in tree-like architecture 300. The process may be generalized to find the n-cost of a node in tree-like architecture 300, given the (n−1)-cost of nodes lying below the node in tree-like architecture 300. The n-cost thus determined corresponds to a lookup architecture that can do a lookup in at most n memory accesses, and that requires minimum amount of memory.

From a table of minimum costs corresponding to the worst case number of accesses, the optimal lookup architecture can be generated. If a bound of k is desired on the lookup architecture, then the k-cost of the root of tree-like architecture 300 and the 1-cost through (k−1)-cost of all other nodes in tree-like architecture 300 is determined. Then the optimal lookup architecture can be generated by using the size of lookup at the root to achieve this k-cost. In the same manner, the size of lookup at nodes below the root is determined by the size of lookup that is required to achieve the optimal (k−1) cost for those nodes. Similarly nodes at the next level will use the values associated with (k−2) cost. Once the size of lookup (demultiplexing) at each node in tree-like architecture 300 is determined, the optimal lookup architecture meeting a bound k on the number of memory accesses can be generated.

In the above explanation of FIG. 3, a longest prefix Internet Protocol version 4 (IPv4) route lookup is performed. However, this procedure may be easily adapted to any tree-like architecture based longest prefix match such as, for example, a 128 bit IPv6 lookup. In addition, for any node N1 in tree-like architecture 300, the next level node (say N2) stores the most specific route in the path from that node (N1) to the next level node (N2). This is because the lookup architecture needs to store only the longest prefix match.

An example of the process illustrated in FIG. 3 is illustrated in Table 1 below:

TABLE 1

| | 303 | 304 | 306 | 332 | 333 | 334 | 318 | 319 | 322 | 323 | 325 | 326 | 327 | 328 |
|---|---|---|---|---|---|---|---|---|---|---|---|---|---|---|
| 1-cost | 0 | 0 | 0 | 0 | 0 | 0 | 2 | 2 | 2 | 2 | 2 | 2 | 2 | 2 |
| 2-cost | 0 | 0 | 0 | 0 | 0 | 0 | 2 | 2 | 2 | 2 | 2 | 2 | 2 | 2 |
| 3-cost | 0 | 0 | 0 | 0 | 0 | 0 | 2 | 2 | 2 | 2 | 2 | 2 | 2 | 2 |

| | 329 | 330 | 331 |
|---|---|---|---|
| 1-cost | 8 | 8 | 16 |
| 2-cost | min(2 + 2 + 2, 4 + 2 + 2, 8) = 6 | min(2 + 2 + 2, 4 + 2 + 2, 8) = 6 | min(2 + 8 + 8, 4 + 2 +2 + 2 + 2, |
| | | | 8 + 2 + 2 + 2 + 2, 16) = 16 |
| 3-cost | min(2 + 2 + 2, 4 + 2 + 2, 8) = 6 | min(2 + 2 + 2, 4 + 2 + 2, 8) = 6 | min(2, + 6 + 6, 4 + 2 + 2 + 2 + 2, |
| | | | 8 + 2 + 2 + 2 + 2, 16) = 12 |

Cost of doing a lookup to keep a bound, where:
1-cost = keeping a bound of 1 (single lookup)
2-cost = keeping a bound of 2 (2 lookups max.)
3-cost = keeping a bound of 3 (3 lookups max.)

Table 1 contains the optimal costs associated with the lookup of a specific node in tree-like architecture 300. With the use of tree-like architecture 300 and Table 1 in FIG. 3, a cost corresponding to accessing the route table at node 319 is computed. To perform a lookup in one memory access, a length of 1 bit is used and will point to a table of two instructions. A first instruction will return a route lookup failure corresponding to the nonexistent node 305 branch and a second instruction will store a route corresponding to node 306 as a result of the route lookup. Hence, the cost of the lookup is a value of “2”.

As a further example, a cost corresponding to accessing the route table at node 325 is computed. To perform a lookup for node 325 in one memory access, a first instruction will return a lookup failure for the nonexistent node 301 branch and the nonexistent node 302 branch. A second instruction will store a route corresponding to nodes 303 and 304. A third instruction will return a lookup failure for the nonexistent node 317 branch and will store a route corresponding to node 318 as a result of the route lookup. Therefore, the cost of the lookup is a value of 6 (the two failed lookups at nodes 301 and 302, the stored routes corresponding to nodes 303 and 304, the failed lookup at node 317 and the stored route corresponding to node 318).

As still a further example, the costs corresponding to node 331 in terms of memory accesses is computed as follows. One-cost: in this case, we have to do the complete lookup in 1 step. Since the height of this node is equal to 4, one cost will be a single demultiplexing instruction of 4 bits. Hence one-cost =pow(2, 4)=16. Two-cost: in this case we have 4 choices. The first demultiplexing can be of 1 bit (case 1), 2 bits (case 2), 3 bits (case 3), or 4 bits (case 4). Case 1: in this case, two-cost, or cost of doing a lookup in maximum of 2 memory access is: two cost=(cost of demultiplexing 1-bit)+1-cost of node 329+1-cost of node 330; two cost=pow(2, 1)+1-cost of node 329+1-cost of node 330; two cost=2+8+8=18; where the last two values are obtained from Table 1. Case 2: two-cost=pow(2, 2)+1-cost of node 325+1-cost of node 326 +1-cost of node 327+1-cost of node 328; two-cost=4+2+2+2+2; two-cost=12. Case 3: two-cost=pow(2,3)+1-cost of node 318+1-cost of node 319+1-cost of node 322+1-cost of node 323; two-cost=8+2+2+2+2; two-cost=16. Case 4: two-cost=pow(2, 4); two-cost=16. Hence the optimal two-cost=min(18, 12, 16, 16)=12. Similarly, three cost=min(2+8+8, 4+2+2+2+2, 8+2+2+2+2, 16); three-cost=min(18, 12, 16, 16); three-cost=12. All obtained by varying the bits used to do the first demultiplexing, and using two-cost of all nodes at the next level.

Therefore, to generate the optimal lookup architecture (of cost 12) and meeting a bound of three, we have to use a first demultiplexing step of 2 bits at node 331. At node 325, the optimal 2-cost is obtained by using a demultiplexing step of 1 bit (and using a comparison of the other 1 bit). In this fashion, the optimal lookup architecture for tree-like architecture 300 can be generated after the optimal costs of all the nodes in tree-like architecture have been determined.

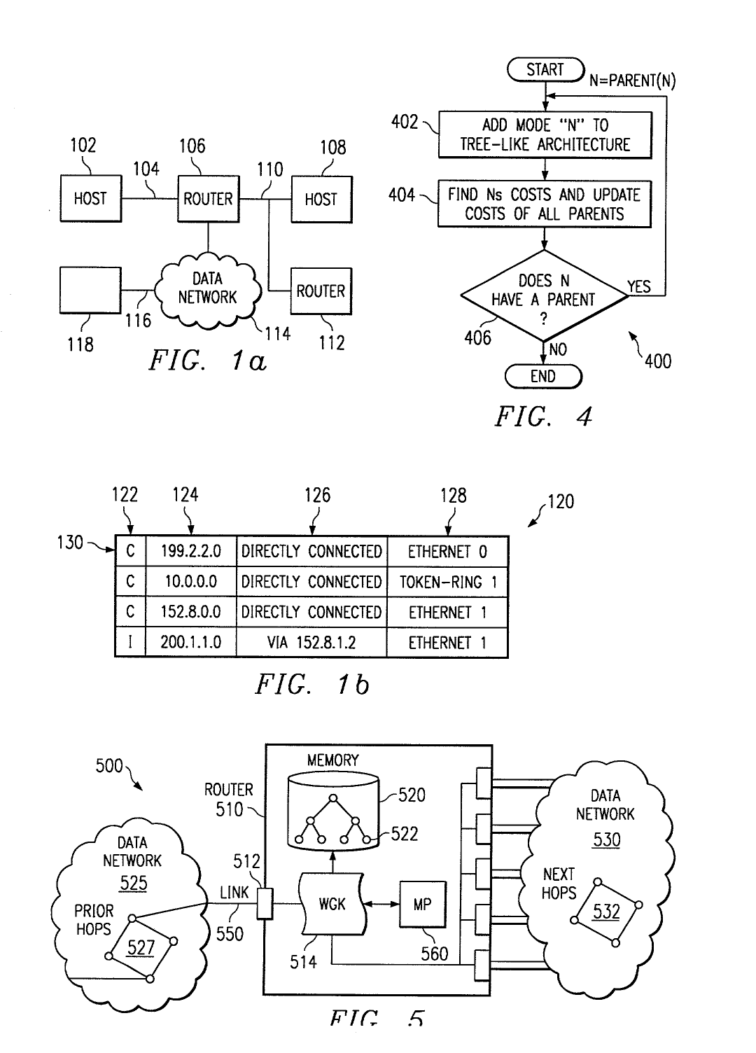

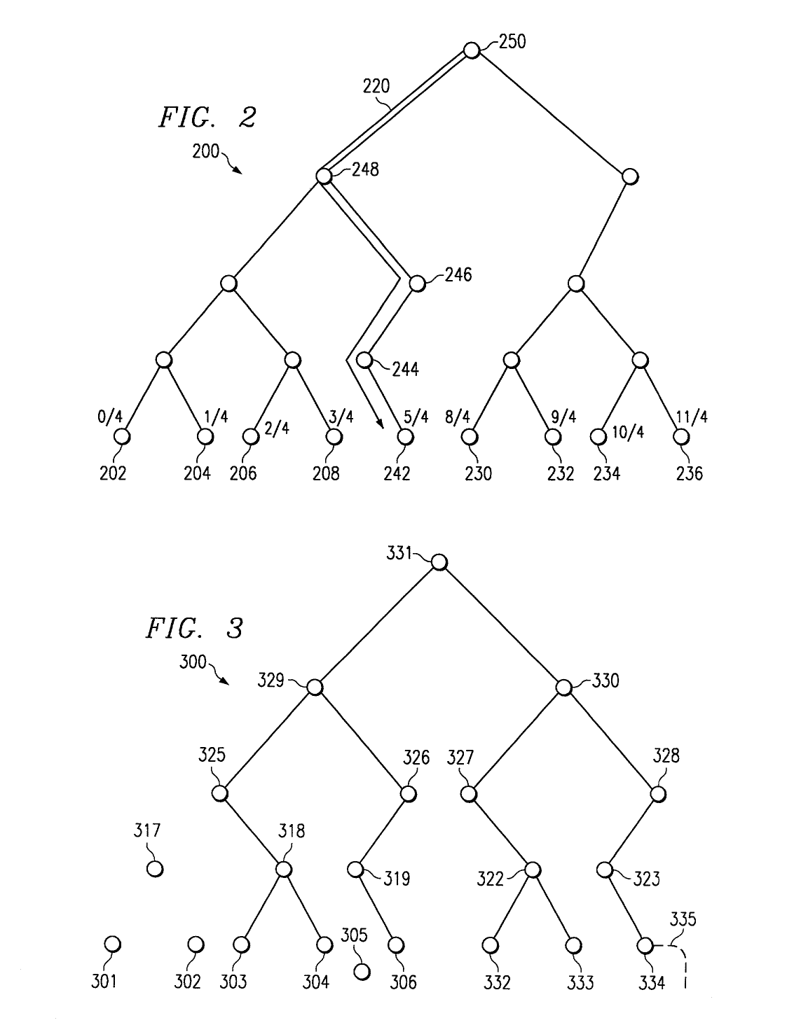

FIG. 4 is an exemplary flowchart illustrating the method, described generally as 400, of incrementally finding the new costs of nodes in tree-like architecture on a topology change (addition/deletion of address prefixes/routes). In this example, the operation begins at step 402 by adding a new node 335, in the tree-like architecture 300. Due to this topology change, all nodes in tree-like architecture 300 in the path from node 335 to the root (node 331) of this tree-like architecture 300 will have to update their costs, step 404. Thus, not all nodes in tree-like architecture will need to calculate their new costs. Once the new costs for nodes in tree-like architecture 300 has been computed, through application of steps 406, 402, 402, repetitively, a new lookup architecture can be generated and used to update the currently used lookup architecture.

The lookup architecture used to lookup routes with a bound on the number of memory accesses, and using a minimum amount of memory can generate a lot of updates due to chagnes in topology. In order to also have a smaller number of updates, this optimal algorithm is applied to nodes at a depth “n” below the root of tree-like architecture 300. Thus, at the root of tree-like architecture 300 we have a singe demultiplexing step of n bits, followed by optimal subtrees rooted at a depth “n” below the root. This optimization helps in reducing the cost of updating the current lookup architecture on a topology change.

A bound on the update cost is obtained by having a bound on the size of the demultiplexing step that can be used at any node in tree-like architecture 300. Thus, when the cost of the optimal subtree rooted at a depth “n” below the root of tree-like architecture 300, exceeds a specified value, the root of the optimal subtree is replaced by a node with maximum lookup size. By using this optimization, the cost of updating the optimal lookup architecture can be bounded by the maximum lookup size.

FIG. 5 exemplary block diagram of a data networking system, denoted generally as 500, using a router 510 adapted for carrying out the methods of the present invention. A data network includes subnetwork 525 and subnetwork 530 which communicate through router 510. Specifically, subnetwork 525 includes one or more prior hops 525 for data reaching the router 510 of the system 500. One or more data links 550 provide the signal pathway between the subnetwork 525 and router 510 which includes an interface 512 to link 550 for receiving data packets from the subnetwork 525 of the data network. Logic means 514 receives data packets from the data network via the interface 512 and is adapted for performing the various packet routing functions such as, for example, determining the destination of received data packets, determining the route to the next hop along a destination, and routing data packets on a route extending to a next hop.

Router 510 is further seen to include a memory space 520 accessible by the logic means 514. Preferably, memory space 520 stores a lookup architecture 522 for achieving route lookup as described above. Specifically, lookup architecture 522 places a bound on the number accesses to the memory space 520 for any destination address of a received data packet service by the router 510. As shown, the routing functions can be facilitated by a processor 560 which works in connection with logic means 514 to implement the route lookup functions and methods of the invention as described herein. Once the next hop from the router 510 is determined using the lookup architecture 522 in memory space 520, a data packet is transmitted to next hops 532 of the subnetwork 530. In this way, route lookup is achieved with the minimum amount of memory necessary to achieve a particular bound and data packets received at the router 510 are transmitted to the next hop in their destination.

Therefore, the present invention provides a process for which a method of performing route lookup that places a bound on the number of accesses to the memory, such as memory space 520. The amount of memory required for the achieving a particular bound is guaranteed to be minimal and scales with an increase in the size of a routing table. Moreover, the addition of deletion of routes from the lookup architecture does not effect the overall costs associated with route lookup and only the routes effected by the add or delete are recalculated.

The embodiments shown and described above are only exemplary. Even though numerous characteristics and advantages of the present invention have been set forth in the foregoing description, together with details of the structure and function of the invention, the disclosure is illustrative only, and changes may be made in the detail, especially in matters of arrangement of the functional parts within the principles of the invention to the full extent indicated by the broad general meaning of the terms used in the attached claims.

What is claimed is:

1. In a data network with router having memory for storing entries for a plurality of destinations from the router, a method of performing route lookup that places a bound on the number of accesses to the memory, the method comprising the steps of:
determining the costs of all possible lookup architectures that can be constructed given the distribution of destinations in the data network;
choosing a lookup architecture which requires the minimum amount of memory to obtain the next hop of any destination and that places a bound on the number of memory accesses to obtain the next hop; and
after receipt of a data packet, using the chosen lookup architecture to lookup a route for a destination address associated with the data packet.

2. The method of claim 1 wherein the step of determining the costs of all possible architectures further comprises the step of determining all possible lookup trees.

3. The method of claim 2 wherein the step of choosing a lookup architecture further comprises the step of choosing a lookup tree that requires the minimum amount of memory to obtain the next hop of any destination and that places a bound on the number of memory accesses to obtain the next hop

4. The method according to claim 1 further comprising the step of arranging the destinations supported by the router in a tree-like architecture.

5. The method according to claim 4 further comprising the step of arranging the destinations supported by the router in a radix tree architecture.

6. The method according to claim 1 further comprising the step of storing the destinations associated with data packets as addresses.

7. The method according to claim 6 further comprising the step of storing the destinations associated with data packets as IP addresses.

8. The method according to claim 1 further comprising the step of calculating the cost associated with performing the route lookup for a data packet.

9. The method according to claim 8 further comprising the step of determining if the cost associated with performing the route lookup is minimum.

10. The method according to claim 9 wherein the cost associated with performing the route lookup is based on the memory required to store the lookup architecture.

11. The method according to claim 9 wherein calculating the cost associated with performing the route lookup is calculated based on a length of a destination address for the data packet.

12. The method according to claim 9 wherein calculating the cost associated with performing the route lookup is calculated by summing values based on a height in which the node is located and costs associated with performing the route lookup of individual routes below the node for which the cost is being calculated.

13. The method according to claim 1 wherein an optimum value associated with performing the route lookup is a cost associated with minimum memory usage in performing the route lookup.

14. The method according to claim 1 wherein the number of accesses to the memory are used to locate a destination address associated with the route.

15. The method according to claim 14 wherein the destination address is an Internet Protocol (IP) destination address.

16. A method for performing a route lookup in a router for a data packet with an associated destination address, the method comprising the steps of:
inspecting the destination address associated with the data packet; and
using the destination address to access a memory space containing a lookup architecture to arrive at the next hop for the data packet which is serviced by the router, wherein the lookup architecture is adapted for bounding the number accesses to the memory space for any destination address of the data packet.

17. The method of claim 16 wherein lookup architecture is further adapted to minimize the amount of memory required to meet any bound on accesses to the memory space for any particular destination address.

18. The method of claim 16 further comprising the steps of”
determining the lookup architecture; and
storing the lookup architecture in the memory space.

19. The method of claim 18 wherein the step of determining the lookup architecture further comprises the steps of:
determining the costs of all possible lookup architectures that can be constructed given the distribution of destinations in the data network containing the router; and
choosing a lookup architecture which requires the minimum amount of memory to obtain the next hop of any destination and that places a bound on the number of memory accesses to obtain the next hop.

20. The method of claim 19 further comprising the step of using the chosen lookup architecture to lookup a route for a destination address associated with the data packet.

21. The method according to claim 18 wherein the step of storing the lookup architecture further comprises the step of storing the lookup architecture in a tree-like architecture.

22. The method according to claim 18 wherein the step of storing the lookup architecture further comprises the step of storing the lookup architecture in a radix tree architecture.

23. The method according to claim 16 further comprising the step of saving the lookup architecture in a routing table containing route information for any destination address serviced by the router.

24. The method according to claim 16 further comprising the step of calculating the cost associated with performing the route lookup for the data packet.

25. The method according to claim 24 further comprising the step of determining with the cost associated with performing the route lookup exceeds a specified value and, if so, replacing the route entry with a destination having a maximum route lookup size.

26. The method according to claim 24 wherein cost associated with performing the route lookup is calculated based on a length of the destination address.

27. The method according to claim 24 wherein the cost associated with performing the route lookup is calculated by summing values based on a height in which the destination is located and costs associated with performing the route lookup of individual routes below the destination for which the cost is being calculated.

28. The method according to claim 24 wherein an optimum value associated with performing the route lookup is a cost associated with a minimum memory usage in performing the route lookup.

29. The method according to claim 16 wherein the destination address is an Internet Protocol (IP) destination address.

30. In a data network including a plurality of destinations and a plurality of routes for reaching the destinations, a router adapted to minimize the costs of route lookup for data packets routed in the data network, the router comprising:
an interface to incoming links of the data network;
logic means for receiving incoming data packets from the data network through said interface and for determining the destination of data packets, determining the route to the next hop along a destination, and routing data packets on a route extending to a next hop; and
a memory space accessible by the logic means and adapted for storing a lookup architecture for routes;
wherein the lookup architecture that places a bound on the number accesses to the memory space for any destination address of the data packet.

31. The router of claim 30 wherein the lookup architecture is further adapted to minimize the amount of memory required to meet any bound on accesses to the memory space for any particular destination address.

32. The router of claim 30 wherein said lookup architecture is arranged as a compressed radix tree.

33. The router of claim 30 wherein the lookup architecture stores an optimum value associated with performing the route lookup in terms of the cost associated with a minimum memory required to meet a particular bound.
